(19) United States
(12) Patent Application Publication
(10) Pub. No.: US 2013/0106822 A1
(43) Pub. Date: May 2, 2013

(54) DISPLAY DEVICE AND METHOD FOR CONTROLLING DISPLAY DEVICE

(71) Applicant: FUJITSU FRONTECH LIMITED, TOKYO (JP)

(72) Inventor: HIROYUKI MATSUO, TOKYO (JP)

(73) Assignee: FUJITSU FRONTECH LIMITED, TOKYO (JP)

(21) Appl. No.: 13/719,915

(22) Filed: Dec. 19, 2012

Related U.S. Application Data
(63) Continuation of application No. PCT/JP2010/061183, filed on Jun. 30, 2010.

(51) Int. Cl. G09G 3/36

(52) U.S. Cl. CPC G09G 3/3696
USPC 345/211; 345/87

(57) ABSTRACT

A display device and a method for controlling a display device is provided by which control is performed so as to perform switching between two booster circuits respectively for high power and low power to be used in a time period that needs high power and a time period that needs low power on the basis of a control signal input to a driver for driving a panel that uses a memory liquid crystal so that a high-power booster circuit is used in a time period that needs high power and a low-power booster circuit is used in the other time periods to maintain a voltage in order to reduce power consumed by a display device.

### CROSS-REFERENCE TO RELATED APPLICATION

This application is a continuation application of International Application PCT/JP2010/061183 filed on Jun. 30, 2010 and designated in the U.S., the entire contents of which are incorporated herein by reference.

### FIELD

The present invention relates to a display device that uses a memory liquid crystal, and to a method for controlling such a display device.

### BACKGROUND

In recent years, panels using a memory liquid crystal are used in various forms in various fields such as the fields of display units of digital books, terminal devices, and the like. As an example of a panel using a memory liquid crystal, there is a panel using a cholesteric liquid crystal. A cholesteric liquid crystal has characteristics such as an ability to maintain displayed contents almost permanently, brilliant color display, a high contrast, and a high resolution. Also, a panel using a memory liquid crystal can maintain displayed contents without a supply of power, and does not need to receive a supply of power except in a panel resetting time period, in which the panel is reset, and in a rendering time period, in which contents are rendered on the panel. Accordingly, a display device utilizing a panel based on a memory liquid crystal can operate on a smaller amount of electricity compared with a type of liquid crystal that requires electricity continuously while it is displaying. Note that the panel resetting time period is a time period in which a rewriting target region in a display unit is reset. The rendering time period is a time period in which previously-rendered contents are deleted and new contents are rendered during the operation of a display device.

However, in order to drive a panel that uses a memory liquid crystal, it is necessary to use a high-power booster circuit to continuously apply a high voltage to a driver for driving a panel in a panel resetting time period and a rendering time period. Also, in order to drive a panel that uses a memory liquid crystal, it is necessary for the driver to ensure the maximum amount of current requested by the panel in a panel resetting time period and a rendering time period. Accordingly, in a conventional booster circuit, it is necessary to continuously supply to the driver the maximum amount of high-power current requested by the panel in a panel resetting time period and a rendering time period.

Also, as a technique for a display device, a configuration is known in which a battery is charged to a prescribed voltage level before a capacitor for boosting is charged so as to reduce a time used for boosting. A technique is also known in which boosting operations are changed in response to the display statuses of a display device that uses a memory liquid crystal so that the minimum necessary power is generated so as to reduce the power consumed by the display device.
Patent Document 1: Japanese Laid-open Patent Publication No. 2007-267539

### SUMMARY

A display device according to one aspect of the present invention having a display unit that uses a memory liquid crystal, a row driver for driving scan lines of the display unit, and a column driver for driving data lines of the display unit includes a control unit of a first booster circuit and a second booster circuit.

The first booster circuit is a high-power booster circuit that outputs a current for driving the display unit, the row driver, and the column driver.

The second booster circuit is a low power consumption booster circuit that outputs a voltage for maintaining a display of the display unit.

The control unit controls the row driver and the column driver, and the control unit refers to timings at which a display data latch signal for defining displayed data and a pulse polarity control signal for avoiding degradation of a liquid crystal change respectively. Moreover, the control unit performs control of switching to the first booster circuit at a timing beforehand set before a timing at which the display data latch signal and the pulse polarity control signal change, and the first booster circuits are switched to the second booster circuit after a prescribed time period has elapsed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram showing an example of a display device according to an embodiment;

FIGS. 2A-2B are a flowchart showing an example of an operation of switching between booster circuits according to an embodiment; and

FIG. 3 is a time chart showing an example of the display device while it is rendering according to an embodiment.

### DESCRIPTION OF EMBODIMENTS

In the present embodiment, two booster circuits respectively for high power and low power are switched for time periods that need high power and low power on the basis of a control signal input to a driver for driving a panel utilizing a memory liquid crystal in order to reduce power consumed by a display device. In other words, switching between two booster circuits is controlled so that a booster circuit for high power is activated in a time period that requires high power, and in the other time period, a booster circuit for lower power that consumes less power is used so that the voltage is maintained.

Detailed explanations will be given to the embodiments by referring to the drawings.

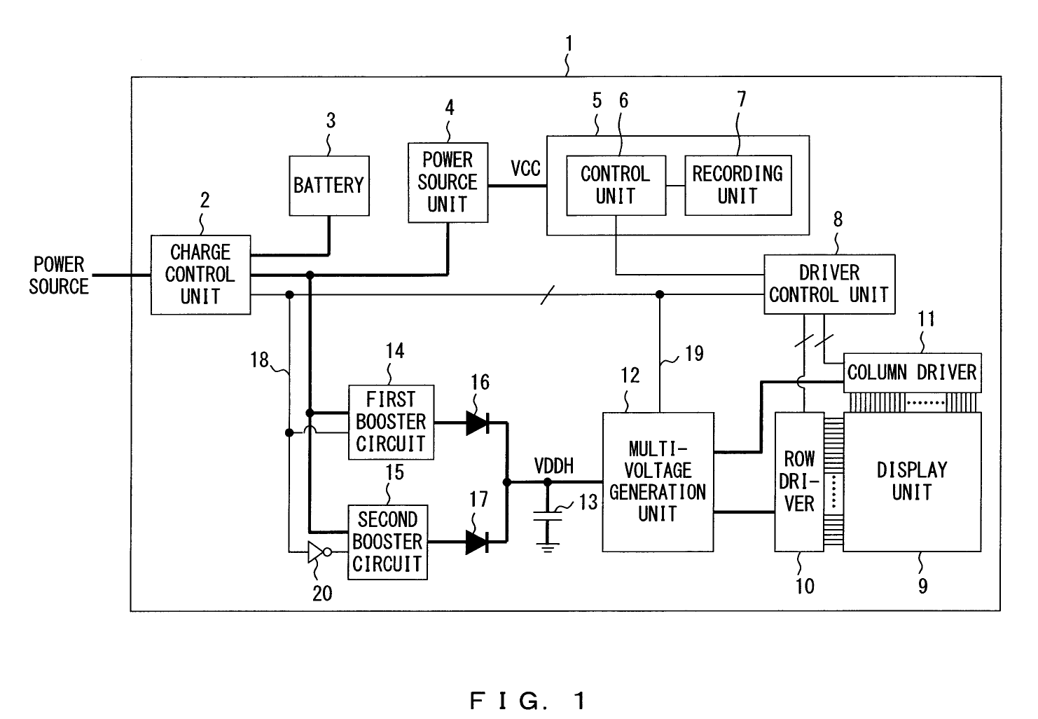

FIG. 1 is a block diagram showing an example of a display device.

A display device 1 includes a charge control unit 2, a battery 3, a power source unit 4, a peripheral circuit 5, a control unit 6, a recording unit 7, a driver control unit 8, a display unit 9, a row driver 10, a column driver 11, a multi-voltage generation unit 12, a capacitor 13, and the like. The display device 1 includes a first booster circuit 14, a second booster circuit 15, rectifier elements 16 and 17, and an inversion element 20.

The charge control unit 2 supplies to the battery 3 power supplied from an external power source such as an alternating current (AC) power source. Also, the charge control unit 2 supplies power to the power source unit 4, the first booster circuit 14, and the second booster circuit 15. When power is not supplied from the external power source, the charge control unit 2 switches power supply paths so that the battery 3 functions as a power source instead of the external power source. Note that if power supplied from the external power source is AC, the charge control unit 2 may convert the current into continuous current (DC).

The battery 3 supplies charged power to the power source unit 4, the first booster circuit 14, and the second booster circuit 15 via the charge control unit 2 when power is not supplied from the external power source.

The power source unit 4 converts power supplied via the charge control unit 2 into a voltage to be used by the peripheral circuit 5. The power source unit 4 is, for example, a three-terminal regulator, an AC-DC converter, a DC-DC converter, or the like.

The peripheral circuit 5 includes a clock source for supplying a clock source signal to each unit in the display device 1, and the control unit 6, the recording unit 7, and the like. Also, the peripheral circuit 5 obtains data through an input device such as a keyboard or a touch panel connected to the display device 1, an image input device such as a camera, a scanner, or the like, and through a network, etc. Also, the peripheral circuit 5 records in the recording unit 7 data obtained via the control unit 6.

The control unit 6 controls each unit in the display device 1. The control unit 6 outputs to the driver control unit 8 display data obtained by the peripheral circuit 5. In the present example, the driver control unit 8 and the control unit 6 are treated separately. However, the control unit 6 may include the function of the driver control unit 8. Also, the control unit 6 may be implemented by using a Central Processing Unit (CPU), a programmable device (Field Programmable Gate Array (FPGA), a Programmable Logic Device (PLD), or the like).

The recording unit 7 stores a program and data for controlling the driver control unit 8, the multi-voltage generation unit 12, the first booster circuit 14, and the second booster circuit 15. Also, the recording unit 7 stores a program, data, and the like for controlling each unit in the display device 1. Note that the recording unit 7 is a memory device such as Read Only Memory (ROM), Random Access Memory (RAM), or the like. Also, the recording unit 7 may record data such as a parameter, a variable, and the like, and also may be used as a work area.

The driver control unit 8 outputs a plurality of types of control signals to the row driver 10 and the column driver 11 via a bus in accordance with instructions from the control unit 6. A plurality of types of control signals are, for example, a display data latch signal LP, a pulse polarity control signal FR, display data DATA, a display data take-in clock signal CLK, and the like. A display data latch signal LP is input to the row driver 10 and the column driver 11. The signal is a pulse for latching display data for the column driver 11, and the signal is a pulse for latching scanned data for the row driver 10. The pulse polarity control signal FR is a voltage polarity reversing control signal for reversing the polarity of the voltages applied from the first booster circuit 14 and the second booster circuit 15 to the row driver 10 and the column driver 11 so as to recover time degradation unique to liquid crystals. A display data DATA is data input to the column driver 11 from the driver control unit 8. Also, this data is for one line that drives a data line for connecting the column driver 11 and the display unit 9. The display data take-in clock signal CLK is a clock used for taking in display data output from the driver control unit 8 to the column driver 11. Note that although six control signals are explained in the present example for simplicity, there are other control signals in addition to the six types of control signals. The number of control signals varies depending upon the type of the display unit 9, the row driver 10, and the column driver 11 used in the display device 1 or upon the type of connection between the display unit 9, the row driver 10, and the column driver 11.

Also, the driver control unit 8 outputs to the first booster circuit 14 and the second booster circuit 15 a boost switching control signal 18 for switching between the first booster circuit 14 and the second booster circuit 15. The timing of outputting a boost switching control signal 18 has been obtained beforehand on the basis of the timing of the change of a display data latch signal LP and a pulse polarity control signal FR recorded in the recording unit 7.

The display unit 9 is a liquid crystal panel that uses a memory displaying material such as a cholesteric liquid crystal. If the display unit 9 is based on the standard of, for example, A4×GA, it has 1024×768 pixels. However, the number of pixels of a liquid crystal panel is not limited to this number.

The row driver 10 drives scanning lines connected to the display unit 9. If the row driver 10 is based on the standard of, for example, A4×GA, it has 768 scanning lines. However, the number of pixels of a liquid crystal panel is not particularly limited. The column driver 11 drives data lines connected to the display unit 9. If the column driver 11 is based on the standard of, for example, A4×GA, it has 1024 data lines. However, the number of pixels of a liquid crystal panel is not particularly limited.

The multi-voltage generation unit 12 receives a voltage control signal 19 from the driver control unit 8, and uses a voltage VDDH output from the first booster circuit 14 and the second booster circuit 15 so as to generate various types of voltages to be supplied to the column driver 11 and the row driver 10, respectively in accordance with the instruction indicated by the voltage control signal 19. The voltage control signal 19 is a signal output from the driver control unit 8, and is used for reporting to the multi-voltage generation unit 12 a voltage value determined in accordance with the method of driving the column driver 11 and the row driver 10.

The capacitor 13 is arranged between the ground and the lines for connecting the first booster circuit 14, the second booster circuit 15, and the multi-voltage generation unit 12so as to smooth voltage VDDH to stabilize it.

The first booster circuit 14 is a circuit that boosts a voltage input from the charge control unit 2 by using a DC-DC converter, or the like. The first booster circuit 14 is a booster circuit of a high-output type, and is used in a time period that requires a high power while being shut down in the other time periods. It is desirable to use a device including a boost control terminal for shutting down the first booster circuit 14. In other words, the first booster circuit 14 is easily shut down by inputting a boost control terminal of the boost switching control signal 18 to a boost control terminal. Note that the first booster circuit 14 boosts voltages to the maximum voltage that is needed for resetting a panel or rendering. For example, it boosts an input voltage from 4.2V to 38V, which is needed for resetting the panel, and boosts an input voltage from 4.2V to 24V, which is needed for rendering when contents are to be rendered. However, how the boosting is performed is not limited to the above examples.

The second booster circuit 15 is a circuit that boosts a voltage input from the charge control unit 2 by using a DC-DC converter. The second booster circuit 15 is a booster circuit of a low-power type, and is used in a time period in which the column driver 11 and the row driver 10 are driven in a low power consumption mode while being shut down in the other time periods. It is desirable to use a device including a boost control terminal for shutting down the second booster circuit 15. In other words, by inputting an inverted signal of the boost switching control signal 18 to a boost control terminal, the second booster circuit 15 is easily shut down. Inverted signals are generated by using, for example, the inversion element 20. Note that voltages are boosted to the maximum voltage needed for resetting the panel or rendering in the boosting operation by the second booster circuit 15. For example, the second booster circuit 15 boosts an input voltage from 4.2V to 24V, which is needed for resetting the panel, and boosts an input voltage from 4.2V to 24V, which is needed for rendering. However, how the boosting is performed is not limited to the above examples.

The rectifier element 16 is arranged between the output terminal of the first booster circuit 14 and the connection point at which the input terminal of the multi-voltage generation unit 12 and the terminal on the voltage VDDH side of the capacitor 13 are connected. The anode terminal of the rectifier element 16 is connected to the output terminal of the first booster circuit 14, and the cathode terminal is connected to the above connection point. The rectifier element 17 is arranged between the output terminal of the second booster circuit 15 and the above connection point. The anode terminal of the rectifier element 17 is connected to the output terminal of the second booster circuit 15, and the cathode terminal is connected to the above connection point. In other words, the connection between the rectifier element 16 and the rectifier element 17 also functions as “diode OR” so as to block the current in the reverse direction.

Explanations will be given to a power switching operation performed by the display device 1.

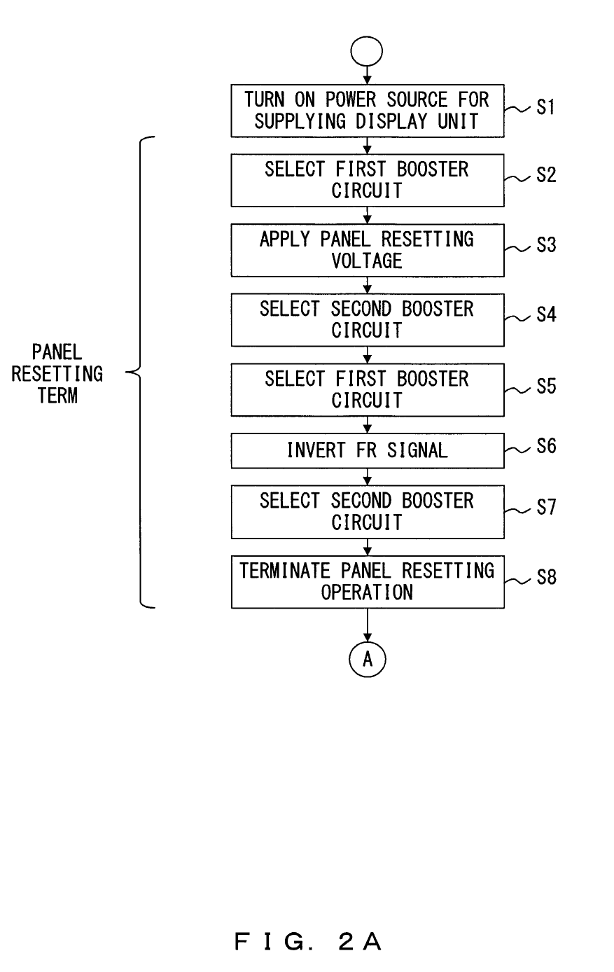

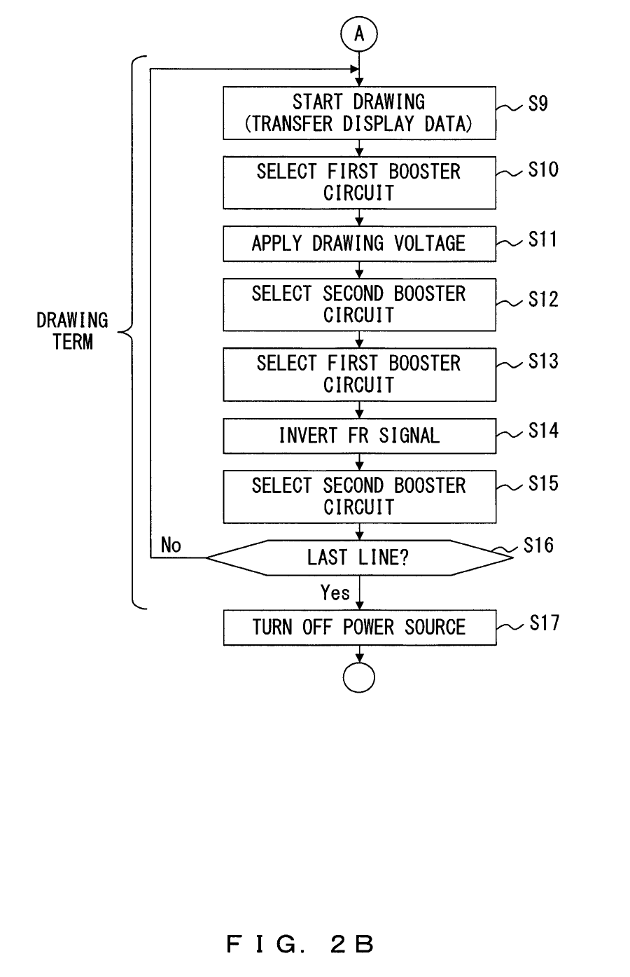

FIG. 2A-2B are a flowchart explaining an example of a process of switching between a high-power booster circuit and a low-power booster circuit. In the display device 1 of the present embodiment, switching is performed between the first booster circuit 14, which is of high-power type, and the second booster circuit 15, which is of a low-power type, in a panel resetting time period for resetting a rewriting target region in the display unit 9 and in a rendering time period for executing rendering.

In step S1 in FIG. 2A, the control unit 6 receives a request to rewrite a displayed image in the display unit 9 from an input device or the like, and instructs the display unit 9 and the power source for supplying power to respective units for driving the display unit 9 to supply power. When the charge control unit 2 supplies power, a rush current is generated to flow into each bypass capacitor and the capacitor 13 of the display device 1.

In step S2, the first booster circuit 14 is selected.

After the driver control unit 8 has received from the control unit 6 a report instructing it to output the boost switching control signal 18 and the voltage control signal 19, the driver control unit 8 outputs the boost switching control signal 18 and the voltage control signal 19. The boost switching control signal 18 holds information for selecting the first booster circuit 14. The voltage control signal 19 holds setting information on the voltage to be output from the multi-voltage generation unit 12 when the panel is reset. The timing of outputting the boost switching control signal 18 is set before the timing of data latch of the display data latch signal LP or the timing of inverting the pulse polarity control signal FR for that latching. Also, the boost switching control signal 18 is output, taking into consideration the time necessary for the first booster circuit 14 to enter a stable operating state. The timing of inverting the pulse polarity control signal FR, the timing of data latching of the display data latch signal LP, and the timing of outputting the boost switching control signal 18 are beforehand recorded in the recording unit 7 as timing information. Each timing included in this timing information is measured by using, for example, a device including a counting function or a clocking function.

Also, the first booster circuit 14 that has received the boost switching control signal 18 has its shut-down state canceled so that it is activated. The second booster circuit 15 that has received the inverted signal of the boost switching control signal 18 is shut down. In other words, the first booster circuit 14 is selected. The multi-voltage generation unit 12 uses a voltage output from the first booster circuit 14 so as to output a voltage needed for resetting the panel.

Note that although the control unit 6 gives instructions to the driver control unit 8 in the present example, the control unit 6 may give instructions to the first booster circuit 14, the second booster circuit 15, and the multi-voltage generation unit 12 when the control unit 6 has the function of the driver control unit 8.

In step S3, the control unit 6 instructs the driver control unit 8 to apply a panel resetting voltage. The driver control unit 8 that has received the instruction from the control unit 6 outputs, to the column driver 11 and the row driver 10 corresponding to a target region, an instruction to apply the voltage to reset the region as the target of rewriting the displayed image. Thereafter, the column driver 11 and the row driver 10 reset the rewriting target of the displayed image.

In step S4, the second booster circuit 15 is selected.

The control unit 6 outputs to the driver control unit 8 an instruction to switch from the first booster circuit 14 to the second booster circuit 15. After receiving the instruction, the driver control unit 8 outputs the boost switching control signal 18. The boost switching control signal 18 has information for selecting the second booster circuit 15. The timing at which the driver control unit 8 outputs the boost switching control signal 18 is at minimum set to after the completion of the resetting of the rewriting target of the displayed image. The timing at which the booster circuit is switched from the first booster circuit 14 to the second booster circuit 15 is recorded beforehand in the recording unit 7 as timing information. Also, the second booster circuit 15 that has received the inverted signal of the boost switching control signal 18 has its shut-down state canceled so that it is activated. The first booster circuit 14 that has received the boost switching control signal 18 is shut down. In other words, the second booster circuit 15 is selected.

In step S5, the first booster circuit 14 is selected.

After the driver control unit 8 has received from the control unit 6 an instruction to output the boost switching control signal 18, the driver control unit 8 outputs the boost switching control signal 18. The boost switching control signal 18 has information for selecting the first booster circuit 14. The timing at which the driver control unit 8 outputs the boost switching control signal 18 is set before the timing of inverting the pulse polarity control signal FR, and the boost switching control signal 18 is output, taking into consideration a time necessary for the first booster circuit 14 to enter a stable operating state. The timing of inverting the pulse polarity control signal FR and the timing of outputting the boost switching control signal 18 are recorded beforehand in the recording unit 7 as timing information. Each timing included in this timing information is measured by using, for example, a device including a counting function or a clocking function.

Also, the first booster circuit 14 that has received the boost switching control signal 18 has its shut-down state canceled so that it is activated, and the second booster circuit 15 that has received the inverted signal of the boost switching control signal 18 is shut down. In other words, the first booster circuit 14 is selected.

Although the control unit 6 gives instructions to the driver control unit 8 in the present example, the control unit 6 may give instructions to the first booster circuit 14, the second booster circuit 15, and the multi-voltage generation unit 12 when the control unit 6 has the function of the driver control unit 8.

In step S6, the driver control unit 8 reverses the polarity of an applied voltage output from the control unit 6, receives an instruction to recover a time degradation unique to memory liquid crystals, and recovers the time degradation by reversing the polarity of the applied voltage.

In step S7, the second booster circuit 15 is selected.

The control unit 6 outputs to the driver control unit 8 an instruction to switch from the first booster circuit 14 to the second booster circuit 15. After receiving the instruction, the driver control unit 8 outputs the boost switching control signal 18. The boost switching control signal 18 has information for selecting the second booster circuit 15. The timing at which the driver control unit 8 outputs the boost switching control signal 18 is at minimum set to after the completion of the resetting of the rewriting target of the displayed image. The timing at which the booster circuit is switched from the first booster circuit 14 to the second booster circuit 15 is recorded beforehand in the recording unit 7 as timing information. Also, the second booster circuit 15 that has received the inverted signal of the boost switching control signal 18 has its shut-down state canceled so that it is activated. The first booster circuit 14 that has received the boost switching control signal 18 is shut down. In other words, the second booster circuit 15 is selected.

In step S8, the panel resetting operation is terminated.

In step S9 in FIG. 2B, a rendering process is started.

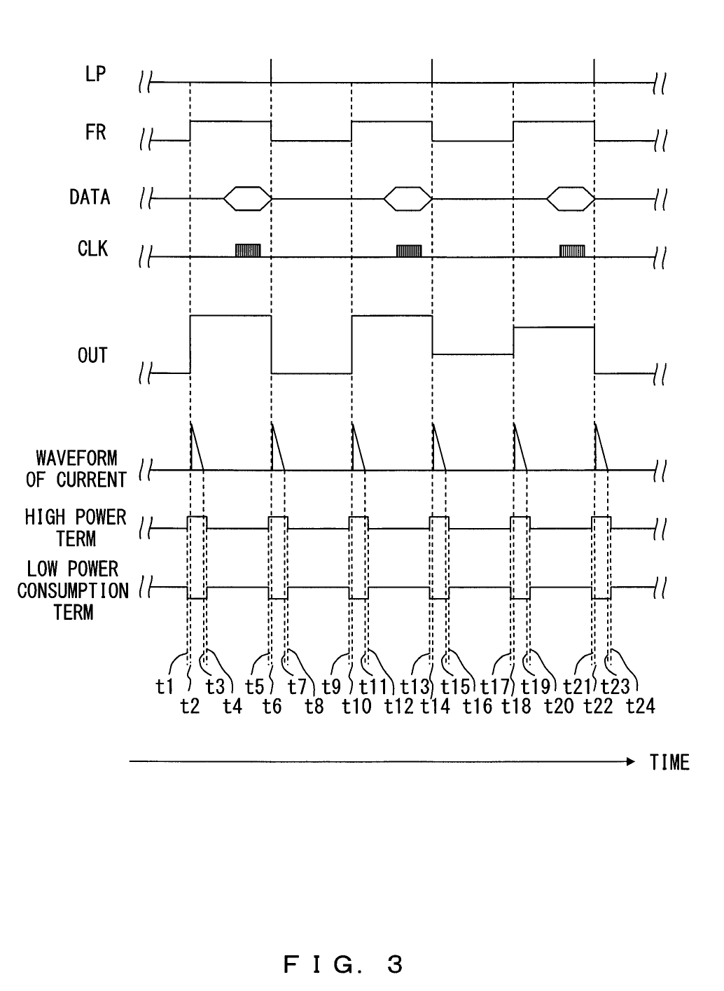

An example of a rendering process will be explained by referring to FIG. 3. In FIG. 3, the vertical axis represents the waveforms of signals, and the horizontal axis represents time. The waveforms of the vertical axis are of a display data latch signal LP, a pulse polarity control signal FR, display data DATA, a display data take-in clock signal CLK, an output voltage OUT, a current input to the first booster circuit 14, the boost switching control signal 18, and the inverted signal of the boost switching control signal 18.

In step S9, the driver control unit 8 transfers display data for one line to the column driver 11 by using a display data take-in clock signal CLK in accordance with an instruction from the control unit 6. In the example shown in FIG. 3, this is performed in the time periods denoted by “t4-t5”, “t12-13”, and “t20-t21”.

In step S10, the first booster circuit 14 is selected.

After the driver control unit 8 has received from the control unit 6 a report instructing it to output the boost switching control signal 18 and the voltage control signal 19, the driver control unit 8 outputs the boost switching control signal 18 and the voltage control signal 19. This is performed at the time points denoted by “t5”, “t13”, and “t21” in the example in FIG. 3.

The boost switching control signal 18 includes information for selecting the first booster circuit 14. The voltage control signal 19 includes setting information for a voltage value output by the multi-voltage generation unit 12 when rendering is performed. The timing of outputting the boost switching control signal 18 is set before the timing of latching the display data latch signal LP or the timing of inverting the pulse polarity control signal FR for that latching. Also, the boost switching control signal 18 is output, taking into consideration a time necessary for the first booster circuit 14 to enter a stable operating state. The timing of reversing the FR, the timing of latching the display data latch signal LP, and the timing of outputting the boost switching control signal 18 are recorded in the recording unit 7 as timing information. Each timing included in this timing information is measured by using, for example, a device including a counting function or a clocking function.

Also, the first booster circuit 14 that has received the boost switching control signal 18 has its shut-down state cancelled, and the second booster circuit 15 that has received the inverted signal of the boost switching control signal 18 is shut down. In other words, the first booster circuit 14 is selected. The multi-voltage generation unit 12 outputs a voltage needed for rendering by using the voltage output from the first booster circuit 14.

Note that although the control unit 6 gives instructions to the driver control unit 8 in the present example, the control unit 6 may give instructions to the first booster circuit 14, the second booster circuit 15, and the multi-voltage generation unit 12 when the control unit 6 has the function of the driver control unit 8.

In step S11, the control unit 6 gives the driver control unit 8 an instruction to apply a rendering voltage. The driver control unit 8 that has received the instruction from the control unit 6 applies a voltage to the column driver 11 and the row driver 10 in order to perform a rendering operation on the display unit 9. In the example in FIG. 3, this is performed at the time periods denoted by “t6-t7”, “t14-t15”, and “t22-t23”.

In step S12, the second booster circuit 15 is selected.

The control unit 6 outputs to the driver control unit 8 an instruction to switch from the first booster circuit 14 to the second booster circuit 15. After receiving the instruction, the driver control unit 8 outputs the boost switching control signal 18. This is performed at the time points denoted by “t8”, “t16”, and “t24”.

The boost switching control signal 18 includes information for selecting the second booster circuit 15. The timing at which the driver control unit 8 outputs the boost switching control signal 18 is at minimum set to after the completion of the resetting of the rewriting target of the displayed image. The timing at which the booster circuit is switched from the first booster circuit 14 to the second booster circuit 15 is recorded beforehand in the recording unit 7 as timing information. Also, the second booster circuit 15 that has received the inverted signal of the boost switching control signal 18 has its shut-down state canceled so that it is activated. The first booster circuit 14 that has received the boost switching control signal 18 is shut down. In other words, the second booster circuit 15 is selected.

In step S13, the first booster circuit 14 is selected.

After the driver control unit 8 has received from the control unit 6 a report instructing it to output the boost switching control signal 18, the driver control unit 8 outputs the boost switching control signal 18. This is performed at the time points denoted by “t1”, “t9”, and “t17” in the example in FIG. 3.

The boost switching control signal 18 has information for selecting the first booster circuit 14. The timing at which the driver control unit 8 outputs the boost switching control signal 18 is set before the timing of inverting the pulse polarity control signal FR, and the boost switching control signal 18 is output, taking into consideration at least a time necessary for the first booster circuit 14 to enter a stable operating state. The timing of reversing the pulse polarity control signal FR and the timing of outputting the boost switching control signal 18 are recorded in the recording unit 7 as timing information. Each timing included in this timing information is measured by using, for example, a device including a counting function or a clocking function.

Also, the first booster circuit 14 that has received the boost switching control signal 18 has its shut-down state cancelled so that it is activated, and the second booster circuit 15 that has received the inverted signal of the boost switching control signal 18 is shut down. In other words, the first booster circuit 14 is selected.

Note that although the control unit 6 gives instructions to the driver control unit 8 in the present example, the control unit 6 may give instructions to the first booster circuit 14, the second booster circuit 15, and the multi-voltage generation unit 12 when the control unit 6 has the function of the peripheral circuit 5.

In step S14, the driver control unit 8 receives from the control unit 6 an instruction to recover time degradation unique to memory liquid crystals, and recovers time degradation unique to memory liquid crystals by reversing the polarity of the applied voltage. This is performed in the time periods denoted by “t2-t3”, “t10-t11”, and “t18-t19”.

In step S15, the second booster circuit 15 is selected.

The control unit 6 outputs to the driver control unit 8 an instruction to switch from the first booster circuit 14 to the second booster circuit 15. The driver control unit 8 receives the instruction, and outputs the boost switching control signal 18. This is performed at the time points denoted by “t4”, “t12”, and “t20” in the example in FIG. 3.

The boost switching control signal 18 includes information for selecting the second booster circuit 15. The timing at which the driver control unit 8 outputs the boost switching control signal 18 is at minimum set to after the pulse polarity control signal FR has been inverted completely. The timing at which the booster circuit is switched from the first booster circuit 14 to the second booster circuit 15 is recorded beforehand in the recording unit 7 as timing information. Also, the second booster circuit 15 that has received the inverted signal of the boost switching control signal 18 has its shut-down state canceled so that it is activated. The first booster circuit 14 that has received the boost switching control signal 18 is shut down. In other words, the second booster circuit 15 is selected.

In step S16, the control unit 6 or the driver control unit 8 determines whether or not the current line is the last line, and when it is the last line, the process proceeds to step S17. When the current line is not the last line, the process proceeds to step S9. For example, it is determined whether or not the current line is the 768-th line when the display unit 9 is based on the standard of, for example, A4×GA.

In step S17, the control unit 6 detects the completion of rewriting of the displayed image in the display unit 9, and outputs, to the power source supplying the power to the display unit 9 and the respective units that are driving the display unit 9, an instruction to stop supplying the power.

According to the present embodiment, supplied currents vary depending upon the load on the display unit 9 and the contents being displayed; however, a booster circuit that is capable of outputting a high power is used in a time period that needs a high power in the respective panel resetting time periods and rendering time periods while a booster circuit that consumes less power is used in the other time periods. This results in lower power consumption in panel resetting time periods and rendering time periods.

Also, a large part of the power necessary in rendering time periods can be reduced, making it possible to use effectively limited power such as in the case of batteries.

The scope of the present invention is not limited to the above embodiments, and various modifications and alterations are allowed without departing from the spirit of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments) of the present invention have been described in detail, it should be understood that the various changes, substitutions, and alterations could be made hereto without departing from the spirit and scope of the invention.

What is claimed is:

1. A display device including a display unit that uses a memory liquid crystal, a row driver for driving scan lines of the display unit, and a column driver for driving data lines of the display unit, the display device comprising:
a first booster circuit that outputs a current for driving the display unit, the row driver, and the column driver;
a second booster circuit that outputs a voltage that maintains a display of the display unit; and
a control unit that refers to timings at which a display data latch signal for defining displayed data and a pulse polarity control signal for avoiding degradation of a liquid crystal change respectively so as to switch to the first booster circuit at a timing set beforehand before a timing at which the display data latch signal and the pulse polarity control signal change so that the booster circuits are switched to the second booster circuit after a prescribed time period has elapsed, the display data latch signal and pulse polarity control signal being for controlling the row driver and the column driver.

2. The display device according to claim 1, wherein:
the control unit switches between the first booster circuit and the second booster circuit in a time period for resetting a panel of the display unit and a time period for rendering.

3. The display device according to claims 1, wherein:
the control unit selects only one of the first booster circuit and the second booster circuit so as to perform switching control.

4. A method for controlling a display device including a display unit that uses a memory liquid crystal, a row driver for driving scan lines of the display unit, and a column driver for driving data lines of the display unit, the method making a computer execute processes of:
referring to timings at which a display data latch signal for defining displayed data and a pulse polarity control signal for avoiding degradation of a liquid crystal change respectively, the display data latch signal and pulse polarity control signal being stored in a recording unit and for controlling the row driver and the column driver;
switching to the first booster circuit that outputs a current for driving the display unit, the row driver, and the column driver, at a timing set beforehand before a timing at which the display data latch signal and the pulse polarity control signal change; and
switching to the second booster circuit that outputs a voltage for maintaining a display of the display unit, after a prescribed time period has elapsed.

5. The method for controlling a display device according to claim 4, wherein:
the computer executes:
switching between the first booster circuit and the second booster circuit in a time period for resetting a panel of the display unit and a time period for rendering.

6. The method for controlling a display device according to claim 4, wherein:
the computer executes:
selecting only one of the first booster circuit and the second booster circuit so as to perform switching.
